(19) United States
(12) Patent Application Publication
(10) Pub. No.: US 2025/0192316 A1
(43) Pub. Date: Jun. 12, 2025

(54) CROSS-MEMBER AND COMPRESSION END PLATE INTERFACES FOR TRACTION BATTERY CELL STACKS

(71) Applicant: FORD GLOBAL TECHNOLOGIES, LLC, Dearborn, MI (US)

(72) Inventors: Kanchana Perumalla, Troy, MI (US); Alex Revels, Canton, MI (US)

(21) Appl. No.: 18/781,100

(22) Filed: Jul. 23, 2024

Related U.S. Application Data
(60) Provisional application No. 63/607,888, filed on Dec. 8, 2023.

(51) Int. Cl. H01M 50/262; B60L 50/64; H01M 50/211; H01M 50/227; H01M 50/242

(52) U.S. Cl. CPC H01M 50/262; B60L 50/64; H01M 50/211; H01M 50/227; H01M 50/242; H01M 2220/20

(57) ABSTRACT

Battery cell stack designs are provided for traction battery packs. An exemplary cell stack may include a cross-member assembly and a compression end plate that may be secured together at one or more mating connections for maintaining the cell stack together before a future assembly into a full traction battery pack. The compression end plates may tie into the cross-member assemblies via one or more mateable retention features for establishing the mating connections and allowing the compression end plates to apply a compressive load across the cell stack. Subsequently, a structural megabar may be mounted to the cross-member assembly for further structurally integrating the traction battery pack.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to cell stack cross-member-to-compression end plate connections within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first cross-member assembly including a ladder frame having a first retention feature, and a compression end plate including a second retention feature that is configured to engage the first retention feature for securing the compression end plate to the first cross-member assembly.

In a further non-limiting embodiment of the foregoing traction battery pack, the ladder frame is made of a thermoplastic material and includes a plurality of cell tab openings each sized to receive a terminal of one or more battery cells that are supported by the first cross-member assembly.

In a further non-limiting embodiment of either of the foregoing traction battery packs, the ladder frame includes a vent opening.

In a further non-limiting embodiment of any of the foregoing traction battery packs, a pultruded reinforcement beam is attached to the ladder frame.

In a further non-limiting embodiment of any of the foregoing traction battery packs, the first retention feature provides a female portion of a mating connection between the first cross-member assembly and the compression end plate, and the second retention feature provides a male portion of the mating connection.

In a further non-limiting embodiment of any of the foregoing traction battery packs, the first retention feature provides a male portion of a mating connection between the first cross-member assembly and the compression endplate, and the second retention feature provides a female portion of the mating connection.

In a further non-limiting embodiment of any of the foregoing traction battery packs, the first retention feature includes a catch having a slot, and the second retention feature includes a protrusion that is configured to engage the slot to establish a mating connection between the first cross-member assembly and the compression end plate.

In a further non-limiting embodiment of any of the foregoing traction battery packs, the protrusion extends outwardly from a floor of an indentation formed in an exterior facing surface of the compression end plate.

In a further non-limiting embodiment of any of the foregoing traction battery packs, the first retention feature includes a flexible arm having a retention peg, and the second retention feature includes a two-tiered pocket formed in an exterior facing surface of the compression end plate.

In a further non-limiting embodiment of any of the foregoing traction battery packs, the flexible arm is configured to engage a first section of the two-tiered pocket, and the retention peg is configured to engage a second section of the two-tiered pocket to establish a mating connection between the first cross-member assembly and the compression end plate.

In a further non-limiting embodiment of any of the foregoing traction battery packs, the ladder frame includes an integrally formed fastener housing, and a fastener insert is received within the integrally formed fastener housing. The fastener insert is configured to receive a fastener.

In a further non-limiting embodiment of any of the foregoing traction battery packs, a structural megabar is mounted to the first cross-member assembly by the fastener.

A traction battery pack according to another exemplary aspect of the present disclosure includes, among other things, a cell stack including a first cross-member assembly including a first ladder frame having a first retention feature, a battery cell supported by the first ladder frame, and a compression end plate including a second retention feature configured to engage the first retention feature to establish a mating connection between the first cross-member assembly and the compression end plate.

In a further non-limiting embodiment of the foregoing traction battery pack, a structural megabar is mounted to the first cross-member assembly.

In a further non-limiting embodiment of either of the foregoing traction battery packs, the battery cell is supported between the first cross-member assembly and a second cross-member assembly of the cell stack.

In a further non-limiting embodiment of any of the foregoing traction battery packs, the second cross-member assembly includes a second ladder frame having a second, first retention feature, and the compression end plate includes a second, second retention feature configured to engage the second, first retention feature to establish a second mating connection between the second cross-member assembly and the compression end plate.

In a further non-limiting embodiment of any of the foregoing traction battery packs, the first retention feature includes a catch having a slot, and the second retention feature includes a protrusion that is configured to engage the slot to establish the mating connection.

In a further non-limiting embodiment of any of the foregoing traction battery packs, the protrusion extends outwardly from a floor of an indentation formed in the compression end plate.

In a further non-limiting embodiment of any of the foregoing traction battery packs, the first retention feature includes a flexible arm having a retention peg, and the second retention feature includes a two-tiered pocket formed in the compression end plate.

In a further non-limiting embodiment of any of the foregoing traction battery packs, the flexible arm is configured to engage a first section of the two-tiered pocket, and the retention peg is configured to engage a second section of the two-tiered pocket to establish the mating connection.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates select portions of an exemplary cell stack of the traction battery pack of FIG. 2.

FIG. 4 is an exploded view of a cross-member assembly of the cell stack of FIG. 3.

FIG. 5 is a blown-up view of a portion of the cell stack of FIG. 3 and illustrates an exemplary interface between a cross-member assembly and a compression end plate of the cell stack.

FIG. 6 illustrates select portions of another cell stack of a traction battery pack.

### DETAILED DESCRIPTION

This disclosure details battery cell stack designs for traction battery packs. An exemplary cell stack may include a cross-member assembly and a compression end plate that may be secured together at one or more mating connections for maintaining the cell stack together before a future assembly into a full traction battery pack. The compression end plates may tie into the cross-member assemblies via one or more mateable retention features for establishing the mating connections and allowing the compression end plates to apply a compressive load across the cell stack. Subsequently, a structural megabar may be mounted to the cross-member assembly for further structurally integrating the traction battery pack. These and other features are discussed in greater detail in the following paragraphs of this detailed description.

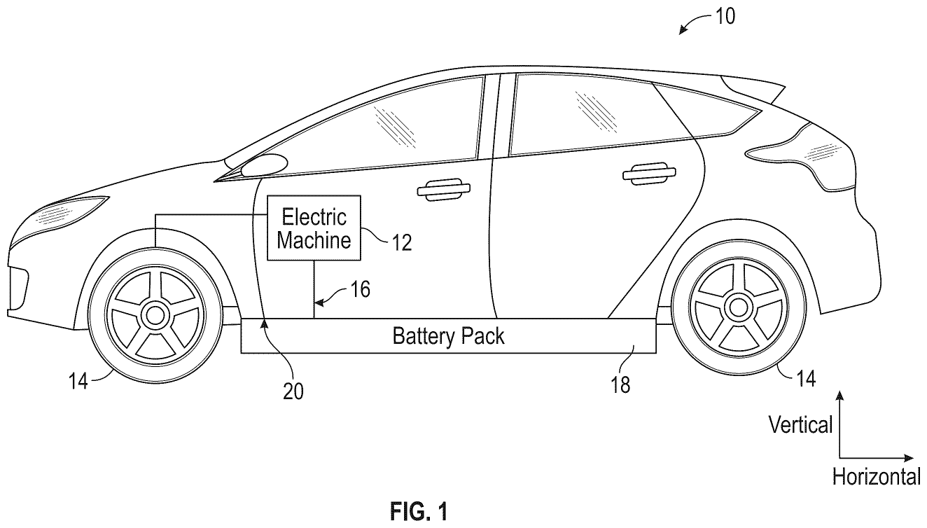

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

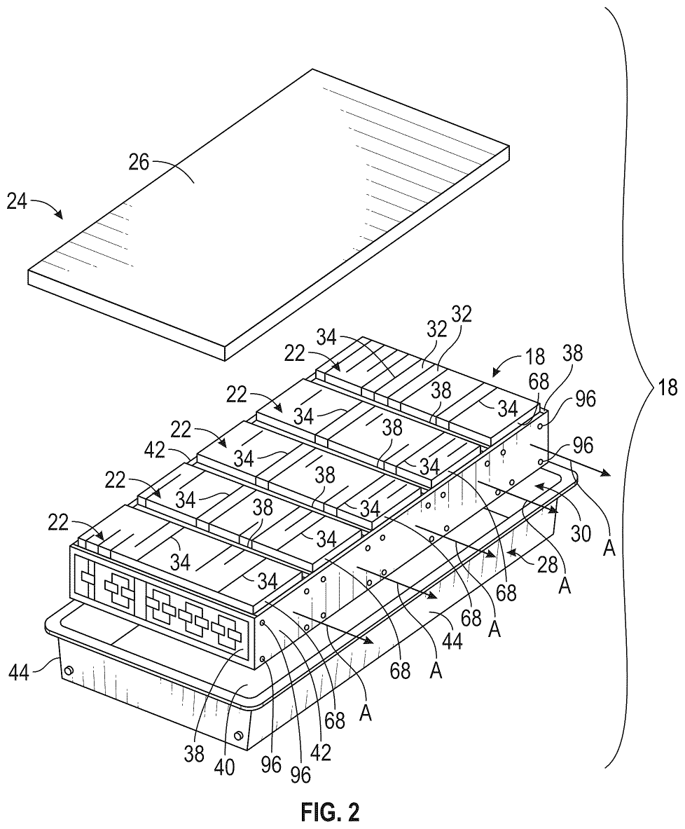

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

The battery cells 32 and the thermal barrier assemblies 34 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

A structural megabar 42 may be positioned between each end of each cell stack 22 and each longitudinally extending side wall 44 of the enclosure tray 28. The structural megabars 42 may be plate-like structures that extend along axes that are substantially transverse (e.g. perpendicular) to the cell stack axes A of the cell stacks 22 and to the cross-member assemblies 38. The structural megabars 42 may span across a majority of the length of the longitudinally extending side walls 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the structural megabars 42 extend longitudinally in a length-wise direction of the electrified vehicle 10. However, other configurations are contemplated within the scope of this disclosure.

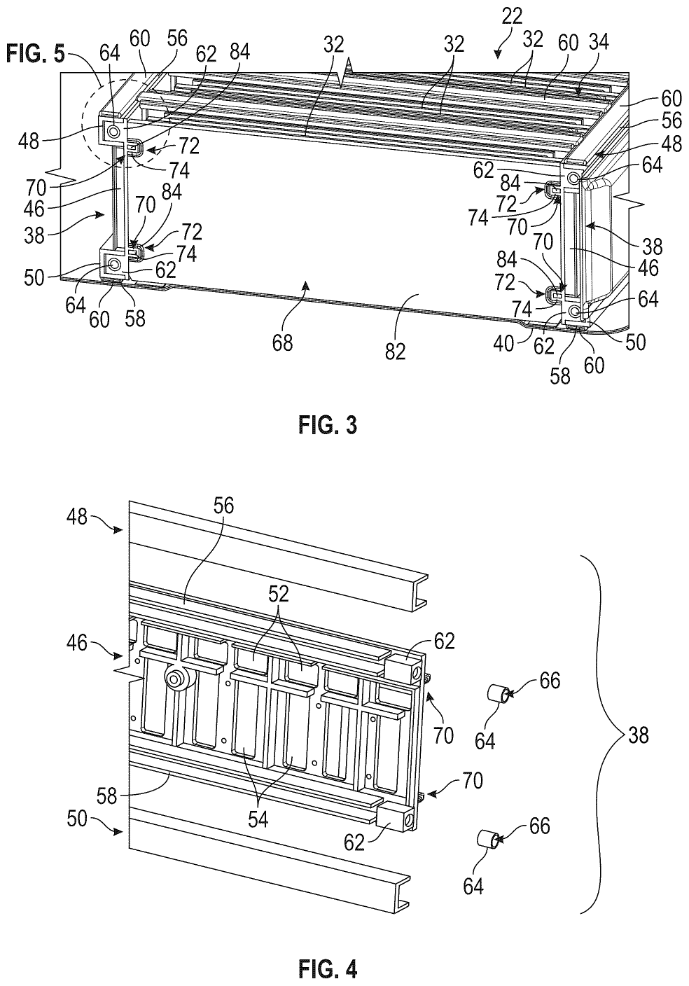

FIGS. 3, 4, and 5, with continued reference to FIG. 2, illustrate additional details associated with a cell stack 22 of the traction battery pack 18. To the extend provided within the traction battery pack 18, any additional cell stacks 22 could include a design that is similar to that shown in FIGS. 3-5.

Each cross-member assembly 38 of the cell stack 22 may include a ladder frame 46 and one or more reinforcement sections. In the illustrated embodiment, each cross-member assembly 38 includes an upper or first reinforcement beam 48 and a lower or second reinforcement beam 50. However, other configurations are also contemplated within the scope of this disclosure.

Each ladder frame 46 may include either a unitary or multi-piece injection molded structure. The ladder frames 46 may be made of any suitable thermoplastic material or combinations of thermoplastic materials.

The ladder frames 46 may include one or more vent openings 52 (see FIG. 4) for communicating battery cell vent byproducts released by one or more battery cells 32 through the ladder frame 46 and into a passageway located between adjacent cell stacks 22. The vent openings 52 may therefore provide a pathway for battery cell vent byproducts to move through the cross-member assembly 38 as may be required during a cell venting event of one or more of the battery cell 32 of the cell stack 22, for example.

The ladder frames 46 may additionally include a plurality of cell tab openings 54 (see FIG. 4) arranged vertically below the vent openings 52. The cell tab openings 54 may be elongated slots configured to accommodate cell tab terminals of the battery cells 32. In an embodiment, each cell tab opening 54 may accommodate one cell tab terminal. In another embodiment, each cell tab opening 54 may be sized to receive cell tab terminals from multiple adjacent battery cells 32 of the cell stack 22.

In an assembled state of each cross-member assembly 38, both the vent openings 52 and the cell tab openings 54 are located between the first and second reinforcement beams 48, 50. However, other configurations are possible within the scope of this disclosure.

The first reinforcement beam 48 and the second reinforcement beam 50 may be mounted at separate locations of the ladder frame 46 for structurally reinforcing each cross-member assembly 38. The ladder frame 46 and the first and second reinforcement beams 48, 50 of each cross-member assembly 38 may include mateable features that facilitate the connection of the first and second reinforcement beams 48, 50 to the ladder frame 46. For example, the ladder frame 46 may include first engagement features that are configured to mesh or interdigitate with a second engagement feature of the first reinforcement beam 48 or the second reinforcement beam 50. In an embodiment, the first engagement features each include a first arrangement of fingers and slots, and the second engagement features each include a second arrangement of fingers and slots. The fingers of the first engagement features can be received in the slots of the second engagement features and vice versa in order to mount the first and second reinforcement beams 48, 50 to the ladder frame 46. Although not shown, an adhesive could be applied between the first and second engagement features for further facilitating the connection of the first and second reinforcement beams 48, 50 to the ladder frame 46.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement beams 48, 50.

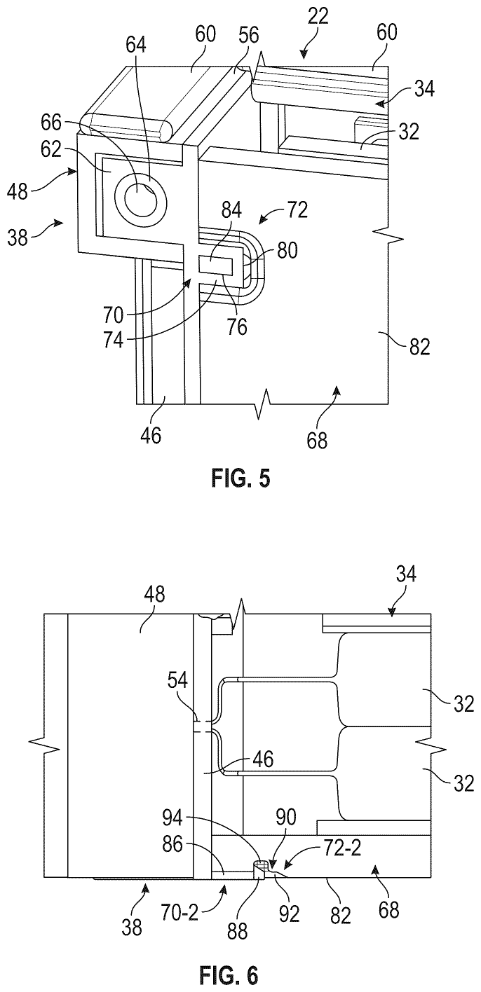

When mounted to the ladder frame 46, the first reinforcement beam 48 may establish an upper plateau 56 of the cross-member assembly 38, and the second reinforcement beam 50 may establish a lower base 58 of the cross-member assembly 38. An adhesive 60 (see FIGS. 3 and 5) may be applied to the upper plateau 56 and to the lower base 58 for securing the cross-member assembly 38 directly to the enclosure cover 26 and to either the heat exchanger plate 40 or the enclosure tray 28, respectively. The adhesive 60 may further be applied between the thermal barrier assemblies 34 and the enclosure cover 26. Each cell stack 22 may therefore be structurally integrated with the enclosure assembly 24 of the traction battery pack 18 via the cross-member assemblies 38 and the thermal barrier assemblies 34.

Each end of the ladder frame 46 may include one or more fastener housings 62 that are each sized to receive a fastener insert 64. Each fastener insert 64 may be made of a thermoset material, for example, and may be received within an opening provided by the fastener housing 62. In an embodiment, the fastener housings 62 are integrally formed (e.g., molded) features located at each corner of the ladder frame 46. The first reinforcement beam 48 and the second reinforcement beam 50 may be appropriately shaped to accommodate the fastener housings 62.

Each fastener insert 64 may include a fastener opening 66 that is configured to receive a fastener 96 (e.g., a bolt or screw, schematically shown in FIG. 2) for mounting the cross-member assembly 38 and thus an associated cell stack 22 to a neighboring structure, such as one of the structural megabars 42, for example. The fastener 96 may be passed through the structural megabar 42 and can then be accommodated within the fastener opening 66 of the fastener insert 64 for mounting the cell stack 22 to the structural megabar 42. This connection can help contain tensile loads that can occur over the life of the cell stack 22 as a result of battery cell expansion forces, for example.

The battery cells 32 and the thermal barrier assemblies 34 may be arranged along the cell stack axis A between opposing compression end plates 68 (only one compression end plate shown in FIGS. 3 and 5). The battery cells 32 and the thermal barrier assemblies 34 may be held in compression along the cell stack axis A between the compression end plates 68.

Each compression end plate 68 may interface with the cross-member assemblies 38 of the cell stack 22 for holding the battery cells 32 and thermal barrier assemblies 34 together prior to inserting the cell stack 22 into the enclosure tray 28 and establishing the structural connection to the structural megabar 42. The ladder frame 46 of each cross-member assembly 38 and each compression end plate 68 may include mateable retention features that facilitate the connection of each compression end plate 68 to the pair of cross-member assemblies 38.

For example, the ladder frame 46 of each cross-member assembly 38 may include first retention features 70 that are configured to engage second retention features 72 of the compression end plates 68 for establishing a mating connection between these neighboring components of the cell stack 22. One or more of the first retention features 70 may be provided on each cross-member assembly 38, and one or more of the second retention features 70 may be provided on each compression end plate 68. In the illustrated embodiment, one first retention feature 70 is provided near each corner of the cross-member assembly 38, and one second retention feature 72 is provided near each corner of the compression end plate 68. However, other configurations are contemplated within the scope of this disclosure.

Each of the first retention features 70 may include a catch 74. A slot 76 may be formed through the catch 74. The catch 74 may be an integrally molded feature of the ladder frame 46 and may protrude away from the ladder frame 46 in a direction toward the opposite cross-member assembly 38 of the cell stack 22.

Each of the second retention features 72 may include an indentation 80 formed in an exterior facing surface 82 of the compression end plate 68. A protrusion 84 may extend outwardly from a floor of the indentation 80. The protrusion 84 may engage the slot 76 of the catch 74 to connect the compression end plate 68 to the cross-member assembly 38 that includes the catch 74. Once connected, the compression end plates 68 can function to apply a compressive load across the cell stack 22 and further to maintain the battery cells 32 and thermal barrier assemblies 34 together as a grouped unit until the cell stack 22 is later positioned in the interior area 30 of the enclosure assembly 24 and tied to the structural megabar 42.

In the above embodiment, the first retention feature 70 provides the female portion of the connection (e.g., a tongue-and-groove connection) between the neighboring cell stack components, and the second retention feature 72 provides the male portion of the connection. However, an opposite configuration is also contemplated in which the first retention feature 70 provides the male portion of the connection and the second retention feature 72 provides the female portion of the connection.

FIG. 6 illustrates one such alternative configuration in which a first retention feature 70-2 of the ladder frame 46 of the cross-member assembly 38 provides the male portion of the connection, and a second retention feature 72-2 of the compression end plate 68 provides the female portion of the connection.

The first retention feature 70-2 may include a flexible arm 86. A retention peg 88 may be positioned at a distal end of the flexible arm 86. The retention peg 88 may extend at a transverse angle relative to a longitudinal axis of the flexible arm 86. The longitudinal axis of the flexible arm 86 extends in parallel with the exterior facing surface 82 of the compression end plate 68, and the retention peg 88 extends at a perpendicular angle relative to the exterior facing surface 82.

The second retention feature 72-2 may include a two-tiered pocket 90 formed in the exterior facing surface 82 of the compression end plate 68. A first section 92 of the two-tiered pocket 90 extends to a first depth within the exterior facing surface 82, and a second section 94 of the two-tiered pocket 90 extends to a second, greater depth within the exterior facing surface 82. The flexible arm 86 may engage the first section 92 of the two-tiered pocket 90 and the peg 88 may engage the second section 94 of the two-tiered pocket 90 to fixedly connect the compression end plate 68 to the cross-member assembly 38 that includes the first retention feature 70-2. Once connected, the compression end plates 68 can function to apply a compressive load across the cell stack 22 and further to maintain the battery cells 32 and thermal barrier assemblies 34 together as a grouped unit until the cell stack 22 is later positioned in the interior area 30 of the enclosure assembly 24 and tied to the structural megabar 42.

The exemplary cell stack cross-member assemblies and compression end plates of this disclosure may engage one another at their interfaces for maintaining a cell stack together before future assembly into a full traction battery pack. The compression end plates may tie into the cross-member assemblies via mateable retention features for establishing a cross-member-to-endplate connection and allowing the end plates to apply a compressive load across the cell stack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first cross-member assembly including a ladder frame having a first retention feature; and
a compression end plate including a second retention feature that is configured to engage the first retention feature for securing the compression end plate to the first cross-member assembly.

2. The traction battery pack as recited in claim 1, wherein the ladder frame is comprised of a thermoplastic material and includes a plurality of cell tab openings each sized to receive a terminal of one or more battery cells that are supported by the first cross-member assembly.

3. The traction battery pack as recited in claim 1, wherein the ladder frame includes a vent opening.

4. The traction battery pack as recited in claim 1, comprising a pultruded reinforcement beam attached to the ladder frame.

5. The traction battery pack as recited in claim 1, wherein the first retention feature provides a female portion of a mating connection between the first cross-member assembly and the compression end plate, and the second retention feature provides a male portion of the mating connection.

6. The traction battery pack as recited in claim 1, wherein the first retention feature provides a male portion of a mating connection between the first cross-member assembly and the compression end plate, and the second retention feature provides a female portion of the mating connection.

7. The traction battery pack as recited in claim 1, wherein the first retention feature includes a catch having a slot, and the second retention feature includes a protrusion that is configured to engage the slot to establish a mating connection between the first cross-member assembly and the compression end plate.

8. The traction battery pack as recited in claim 7, wherein the protrusion extends outwardly from a floor of an indentation formed in an exterior facing surface of the compression end plate.

9. The traction battery pack as recited in claim 1, wherein the first retention feature includes a flexible arm having a retention peg, and the second retention feature includes a two-tiered pocket formed in an exterior facing surface of the compression end plate.

10. The traction battery pack as recited in claim 9, wherein the flexible arm is configured to engage a first section of the two-tiered pocket and the retention peg is configured to engage a second section of the two-tiered pocket to establish a mating connection between the first cross-member assembly and the compression end plate.

11. The traction battery pack as recited in claim 1, wherein the ladder frame includes an integrally formed fastener housing, and comprising a fastener insert received within the integrally formed fastener housing, wherein the fastener insert is configured to receive a fastener.

12. The traction battery pack as recited in claim 11, comprising a structural megabar mounted to the first cross-member assembly by the fastener.

13. A traction battery pack, comprising:
a cell stack including:
a first cross-member assembly including a first ladder frame having a first retention feature;
a battery cell supported by the first ladder frame; and
a compression end plate including a second retention feature configured to engage the first retention feature to establish a mating connection between the first cross-member assembly and the compression end plate.

14. The traction battery pack as recited in claim 13, comprising a structural megabar mounted to the first cross-member assembly.

15. The traction battery pack as recited in claim 13, wherein the battery cell is supported between the first cross-member assembly and a second cross-member assembly of the cell stack.

16. The traction battery pack as recited in claim 15, wherein the second cross-member assembly includes a second ladder frame having a second, first retention feature, and the compression end plate includes a second, second retention feature configured to engage the second, first retention feature to establish a second mating connection between the second cross-member assembly and the compression end plate.

17. The traction battery pack as recited in claim 13, wherein the first retention feature includes a catch having a slot, and the second retention feature includes a protrusion that is configured to engage the slot to establish the mating connection.

18. The traction battery pack as recited in claim 17, wherein the protrusion extends outwardly from a floor of an indentation formed in the compression end plate.

19. The traction battery pack as recited in claim 13, wherein the first retention feature includes a flexible arm having a retention peg, and the second retention feature includes a two-tiered pocket formed in the compression end plate.

20. The traction battery pack as recited in claim 19, wherein the flexible arm is configured to engage a first section of the two-tiered pocket and the retention peg is configured to engage a second section of the two-tiered pocket to establish the mating connection.
